(19) United States
(12) Patent Application Publication
(10) Pub. No.: US 2007/0030766 A1
(43) Pub. Date: Feb. 8, 2007

(54) Multiple-drive recording and reproduction apparatus

(75) Inventor: Yoichiro Tanaka, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/496,468

(22) Filed: Aug. 1, 2006

(30) Foreign Application Priority Data
Aug. 2, 2005 (JP) 2005-224374

(51) Int. Cl. G11B 21/08

(52) U.S. Cl. 369/30.05

(57) ABSTRACT

A multiple-drive recording and reproduction apparatus of the invention includes a system controller which, upon duplication of information recorded on a hard disc onto an optical disc, on the hard disc device side, compresses and tentatively reproduces, at a bit rate changed, predetermined time's worth of video data from the beginning of a video and displays the video on a display part, and, if the user views and approves rough image quality of the video tentatively reproduced and displayed, compresses the video data targeted for duplication and then starts the duplication. According to this configuration, when the recording bit rate is changed upon the duplication of the information from the hard disc to the optical disc, the video at this point can be confirmed. Therefore, upon the duplication of the information recorded on the hard disc to the optical disc, the user can be notified in advance that setting the bit rate of recording on the optical disc too low results in rough image quality of the video when reproduced from the optical disc. Consequently, the video reproduced after duplication is prevented from appearing hardly visible, thus avoiding user discomfort, failure in duplication, and waste of the optical disc.

This application is based on JP-A-2005-224374 filed on Aug. 2, 2005, the contents of which are hereby incorporated by reference.

### BACKGROUND OF THE INVENTION

1. Field of the Invention

The present invention relates to a multiple-drive recording and reproduction apparatus provided with: an optical disc device that performs information recording and reproduction on an optical disc; and a hard disc device that performs information recording and reproduction on a hard disc, and more specifically to processing of duplicating information recorded on the hard disc to the optical disc.

2. Description of Related Art

In recent years, multiple-drive recording and reproduction apparatuses have been wide spread which are provided with an optical disc device, such as a DVD (digital versatile disc), that performs information recording and reproduction on an optical disc, and a hard disc device that performs information recording and reproduction on an HD (hard disc). In such a multiple-drive recording and reproduction apparatus, in case of recording a TV broadcast program, setting the DVD recording mode permits the program to be recorded onto a DVD (writable DVD-R, rewritable DVD-RW, or the like) while setting the HD recording mode permits the program to be recorded onto the HD.

Typically, for example, in case of recording a TV program with such a multiple-drive recording and reproduction apparatus, the HD recording mode is, in many cases, set to record the program on the HD side having a larger capacity than the DVD. Then, in some cases, some users desire to duplicate a desired program from the HD to the DVD. The point to be considered in such duplication is that the bit rate at the DVD recording mode may be set lower than the bit rate at the HD recording mode so that one piece of information or pieces of information recorded on the HD can be recorded onto one DVD.

However, upon the duplication of the information recorded on the HD onto the DVD, lowing the low bit rate of recording on the DVD too much for effective use of the capacity of one DVD results in rough image quality of the video, i.e., a hardly visible video, when reproduced from the DVD, which causes user discomfort. This means failure in the duplication operation, thus leading to a problem that the optical disc in particular, such as a non-rewritable DVD-R or the like, could be spoiled.

In prior art described in JP-A-2003-324680, to perform rate conversion of moving image data cumulated on a hard disc upon duplication onto the DVD, rate conversion with high image quality can be achieved by performing this rate conversion based on information (encoding statistics value) previously imbedded in the stream of the non-converted moving image data at a predetermined gap for later use upon its execution. However, due to no measure provided, this fails to solve a problem such that, upon the duplication of the information recorded on the hard disc to the DVD, lowing the bit rate of recording on the DVD for effective use of the capacity of one DVD results in rough image quality of a video, i.e., a hardly visible video, when reproduced from the DVD.

In prior art of JP-A-2004-127470, when the data rates of a duplication destination and a duplication source agree with each other, compressed image data read from a hard disc is supplied directly to an optical disc. On the other hand, when these data rates do not agree with each other, the compressed image data is decoded and then encoded again to be recorded onto the optical disc. This, however, fails to confirm, before starting the duplication from the hard disc to the optical disc, what level of image quality is provided to a video generated by the compressed image data, thus resulting in failure to solve the problem as described above.

In prior art of JP-A-2005-50395, recording information recorded on a hard disc in correspondence with the storage capacity and the like of a DVD is duplicated to the DVD while maintaining the information volume thereof, which fails to confirm, before starting the duplication from the hard disc to the optical disc, what level of image quality is provided to a vide to be duplicated, thus resulting in failure to solve the problem as described above.

### SUMMARY OF THE INVENTION

The invention has been made to solve the problems as described above, and it is an object of the invention to provide a multiple-drive recording and reproduction apparatus capable of confirming a video in the event of change in the recording bit rate upon duplication of information from a hard disc to an optical disc.

To achieve the object described above, according to one aspect of the invention, a multiple-drive recording and reproduction apparatus including: an optical disc device that performs information recording and reproduction on an optical disc; and a hard disc device that performs information recording and reproduction on a hard disc, further includes a system controller which, upon duplication of the information recorded on the hard disc to the optical disc, on a hard disc device side, compresses and tentatively reproduces, at a bit rate changed, predetermined time's worth of video data from beginning of a video and displays the video on a display part, and if a user views and approves rough image quality of the video tentatively reproduced and displayed, compresses the video data targeted for duplication and starts the duplication.

In this configuration, upon the duplication of the information recorded on the hard disc to the optical disc, on the hard disc device side, the predetermined time's worth of the video data from the beginning of the video is compressed at the bit rate changed, and the video tentatively reproduced is displayed on the display part. Then, if the user views and approves rough image quality of the video displayed, the video data targeted for duplication is compressed and the duplication is started.

According to another aspect of the invention, an multiple-drive recording and reproduction apparatus including: an optical disc device that performs information recording and reproduction on an optical disc, and a hard disc device that performs information recording and reproduction on a hard disc, further includes a system controller having: a compression judgment part which judges, on a duplication setting screen displayed upon duplication mode setting for duplication of the information recorded on the hard disc to the optical disc, whether or not an instruction for compressing video data to be duplicated by changing a bit rate to a lower rate is provided; a tentative reproduction part which, if it is judged that the instruction for the compression is provided and then when an instruction for confirming a video to be reproduced at the bit rate is provided, on the hard disc device side, compresses and tentatively reproduces, at the bit rate, predetermined time's worth of the video data from beginning of the video and displays the video on the display part; and a duplication starting part which, if a user views and approves rough image quality of the video tentatively reproduced and displayed and then when an instruction for executing the duplication is provided, starts the duplication of the compressed video data targeted for duplication.

In this configuration, first, a remote controller is operated to set the multiple-drive recording and reproduction apparatus at the HD-DVD duplication mode, and the duplication setting screen is displayed on the display part, asking the user whether or not to change the bit rate to compress the video data to be duplicated. If the user provides the instruction for the compression, the compression judgment part judges that the video data is to be compressed, and if the user further provides the instruction for confirming the video to be reproduced at the bit rate, the tentative reproduction part, on the hard disc device side, compresses and tentatively reproduces, at the bit rate, the predetermined time's worth of video data from the beginning of the video and displays the video on the display part. Then, if the user views and approves the rough image quality of the video tentatively reproduced and displayed and then when the instruction for executing the duplication is provided, the duplication starting part starts the duplication of the compressed video data targeted for duplication.

According to these configurations, when the recording bit rate is changed upon the duplication of the information from the hard disc to the optical disc, the video at this point can be confirmed. Therefore, upon the duplication of the information recorded on the hard disc to the optical disc, the user can be notified in advance that setting the bit rate of recording on the optical disc too low results in rough image quality of the video when reproduced from the optical disc. Consequently, the video reproduced after duplication is prevented from appearing hardly visible, thus avoiding user discomfort, failure in duplication, and waste of the optical disc.

### BRIEF DESCRIPTION OF THE DRAWINGS

FIG. 1 is a block diagram showing the configuration of a multiple-drive recording and reproduction apparatus of the present invention;

FIG. 2 is a diagram showing one example of a duplication setting screen displayed when the duplication mode is set upon duplication of information from an HD to a DVD;

FIG. 3 is a diagram showing one example of a confirmation screen for confirmation whether or not to execute the duplication with the image quality of a video reproduced tentatively; and

FIG. 4 is a flowchart for explaining processing performed before starting the duplication of the information from the HD to the DVD.

### DETAILED DESCRIPTION OF THE PREFERRED EMBODIMENTS

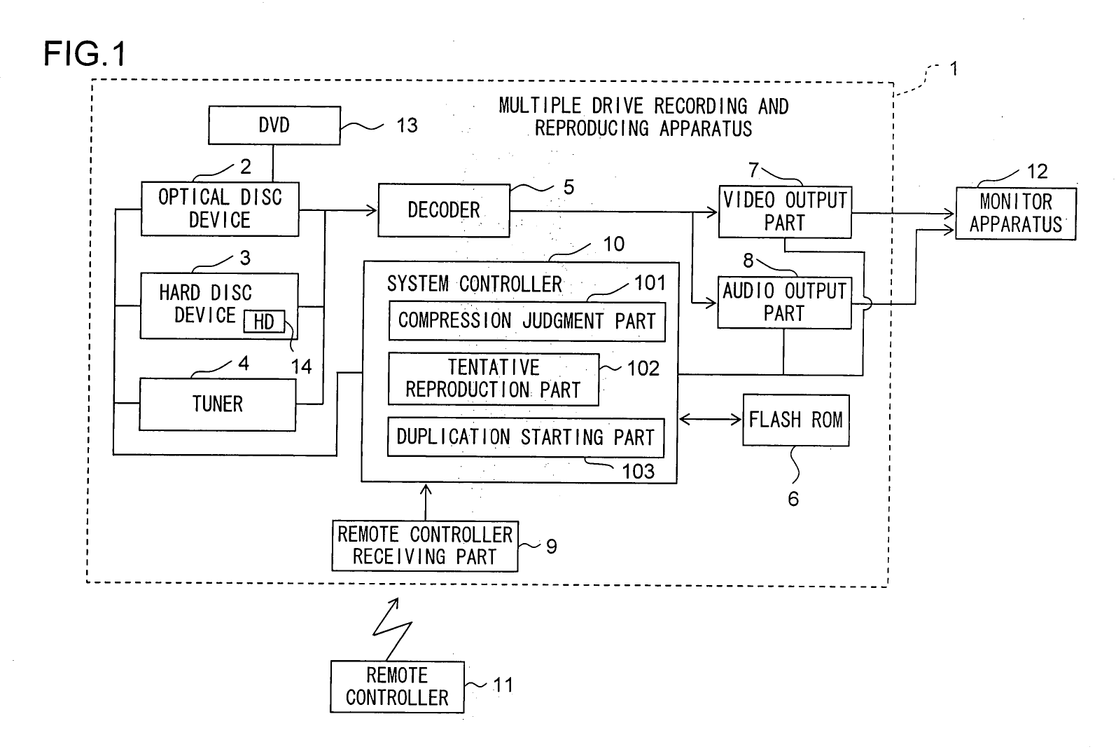

Hereinafter, with reference to the accompanying drawings, the embodiment of the invention will be described. FIG. 1 is a block diagram showing the configuration of a multiple-drive recording and reproduction apparatus according to one embodiment of the invention.

This multiple-drive recording and reproduction apparatus 1 is provided with: an optical disc device 2 as a DVD recorder which performs information recording and reproduction on a DVD (digital versatile disc) 13 as an optical disc; a hard disc device 3 which performs information recording and reproduction on an HD (hard disc) 14; a tuner 4 which receives TV broadcast signals from an antenna, not shown, then selects the TV broad signal of a desired channel, and then outputs it as a video audio signal; a decoder 5 which decodes a video audio signal outputted from the optical disc device 2, the hard disc device 3, or the tuner 4; a flash ROM 6 which stores a broadcast channel that can be received by the tuner 4 and also stores a program and the like required for the operation of a system controller 10; a video output part 7 which converts a video signal decoded by the decoder 5 into a video signal that can be displayed on a monitor apparatus (provided with a display part such as a TV receiver or the like) 12; an audio output part 8 which converts an audio signal decoded by the decoder 5 into an audio signal that can be outputted on the monitor apparatus 12; a remote controller receiving part 9 which receives various command signals of infrared light transmitted from a remote controller 11, converts the received command signals of infrared light into command signals of electrical properties, and inputs these command signals to the system controller 10; and the system controller 10 which controls the entire apparatus.

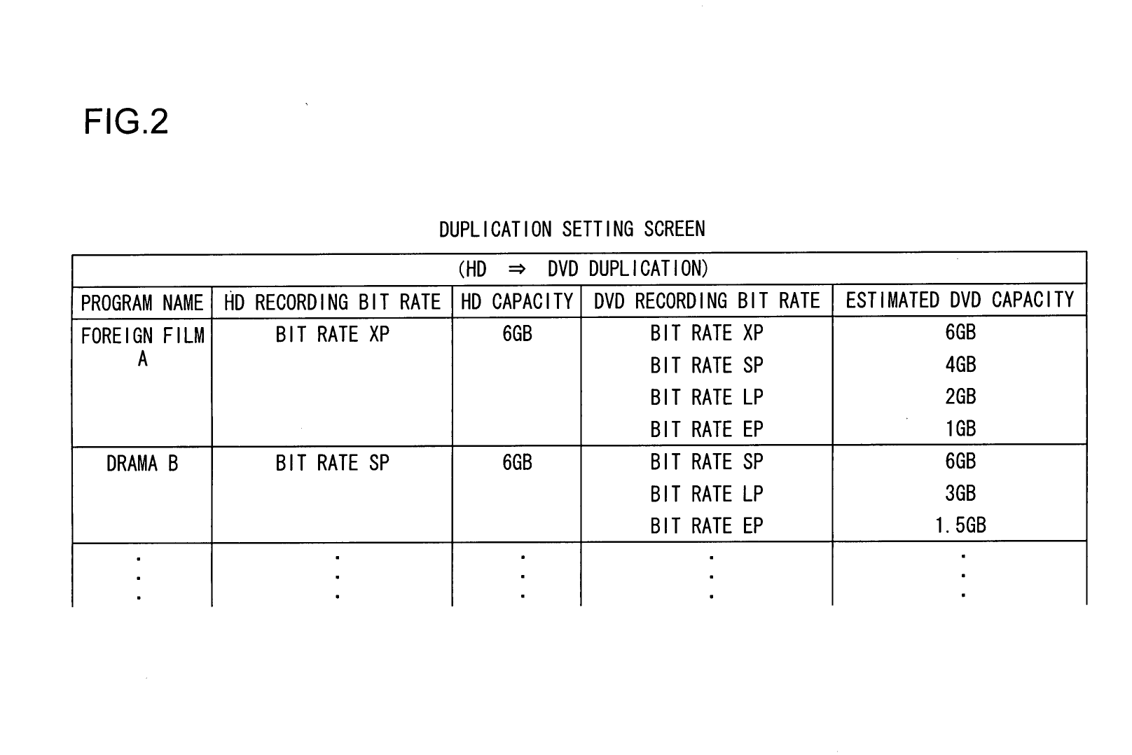

The system controller 10 has, as a feature of this embodiment, a compression judgment part 101, a tentative reproduction part 102, and a duplication starting part 103. The compression judgment part 101 judges whether or not an instruction is provided for compressing data of a video to be duplicated by changing the bit rate to a lower level on a duplication setting screen (see FIG. 2) displayed upon duplication mode setting for duplication of information recorded on the HD (hard disc) 14 to the 13. The tentative reproduction part 102, if the instruction for compression described above is provided and then when an instruction is provided for confirming the video to be reproduced at the bit rate, compresses and tentatively reproduces at the bit rate, on the hard disc device 3 side, predetermined time's worth of video data from the beginning of the video and then displays the video on the monitor apparatus 12. The duplication starting part 103, if an instruction for executing the duplication is provided and then when the user views the and approves the rough image quality of the video tentatively reproduced and displayed, starts duplication of the compressed video data targeted for duplication.

FIG. 2 is a diagram showing one example of the duplication setting screen displayed when the duplication mode is set to perform the duplication of information from the HD to the DVD in this embodiment.

On this duplication setting screen, the program name indicates the name of a program recorded on the HD 14, the HD recording bit rate indicates the recording bit rate at which this program has been recorded onto the HD 14, the HD capacity indicates the capacity occupied by this program when recorded on the HD 14, the DVD recording bit rate indicates the recording bit rate at which this program is recorded onto the DVD 13, and the estimated DVD capacity indicates the estimated capacity occupied by this program when recorded on the DVD 13.

For example, a foreign film theater A is a program recorded onto the HD 14 at the recording mode (video-recording mode) XP (recording mode with the highest bit rate) and occupying 6 GB of the HD capacity. In duplicating the information of this foreign film theater A to the DVD 13, the estimated DVD capacity is 6 GB if the DVD recording bit rate is the XP bit rate, is 4 GB at the bit rate SP, is 2 GB at the bit rate LP, and is 1 GB at the bit rate EP. However, if the rated capacity of the DVD 13 is, for example, 4.7 GB, the bit rate XP is not sufficient for all the information of the foreign film theater A to be recorded, so that the duplication is to be performed with the bit rate SP, LP, or EP.

The user may desire to reduce the recording bit rate for duplication for the most possible effective use of the DVD 13. For example, the user may desire to record the information of the foreign film theater A onto the DVD 13 by reducing the recording bit rate to a minimum possible rate that does not results in rough image quality of the duplicated video, i.e., hardly visible video. For such a case, in this embodiment, if the user views and approves the image quality of the video when the recording bit rate is reduced, the information is recorded (duplicated) onto the DVD 13 with this recording bit rate.

In FIG. 2, a drama B is a program recorded onto the HD 14 at the recording mode (video-recording mode) SP and occupying 6 GB of the HD capacity. When the information of this drama B is duplicated to the DVD 13, the estimated DVD capacity is 6 GB if the DVD recording bit rate is the bit rate SP, is 3 GB at the bit rate LP, and is 1.5 GB at the bit rate EP. For the drama B, the same processing as performed for the foreign film theater A can be performed, although omitted from the description.

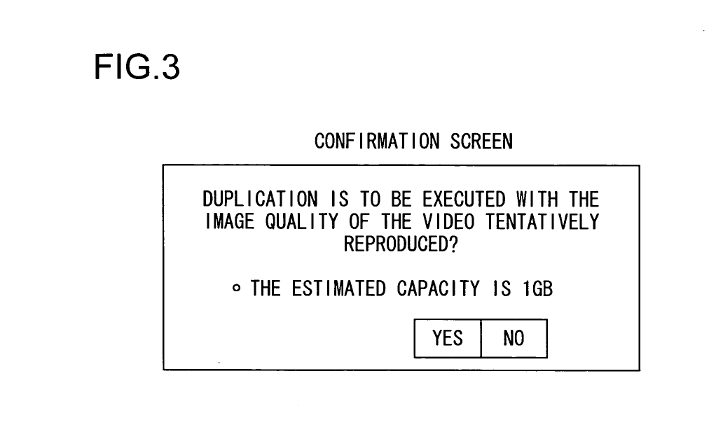

FIG. 3 is a diagram showing one example, in this embodiment, of a confirmation screen for confirming whether or not to execute duplication with the image quality of the video tentatively reproduced. On this confirmation screen, “Duplication is to be executed with the image quality of the video tentatively reproduced?” and “The estimated capacity is 1 GB” are displayed. The remote controller 11 can be operated to select and determine “YES” with a cursor, not shown, in order to execute the duplication with the image quality of the video tentatively reproduced. “NO” can be selected and determined with the same cursor in order not to execute the duplication with the image quality of the video tentatively reproduced.

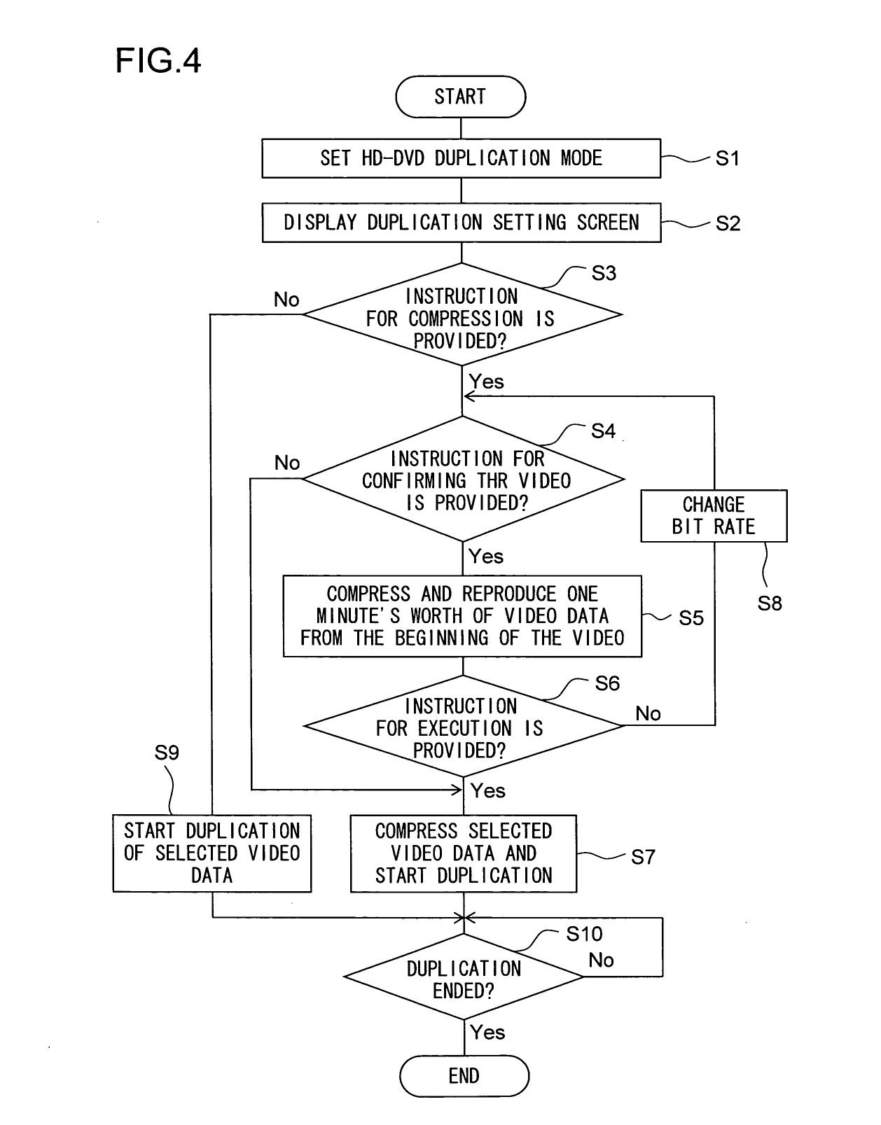

FIG. 4 is a flowchart for explaining processing performed before starting the duplication of information from the HD to the DVD in this embodiment. With reference to this flowchart and FIGS. 1 to 3, the processing performed before starting the duplication of information from the HD to the DVD will be described.

First, the remote controller 11 is operated to set the multiple-drive recording and reproduction apparatus 1 at the HD-DVD duplication mode (step S1), and the system controller 10 displays on the monitor apparatus 12, for example, a duplication setting screen as shown in FIG. 2 (step S2). Then, the remote controller 11 is operated to select the program targeted for duplication and set the DVD recording bit rate upon recording on the DVD 13 at, for example, a minimum bit rate (EP). Thus, the multiple-drive recording and reproduction apparatus 1 asks the user whether or not to compress the video data to be duplicated at this minimum bit rate. If the user provides an instruction for the compression by operating the remote controller 11, the compression judgment part 101 of the system controller 10 judges that there is an instruction from the user for compressing the video data (step S3). If the user provide no instruction for the compression, duplication of the selected video data is started at the recording bit rate previously set (step S9).

If the user provides the instruction for the compression, the user subsequently provides an instruction for confirming the video to be reproduced at the minimum bit rate by operating the remote controller 11 (step S4), so that the tentative reproduction part 102 of the system controller 10 drives the hard disc device 3. As a result, the hard disc device 3 performs reproduction operation on the HD 14, compresses and tentatively reproduces, at the minimum bit rate, one minute's (not limited to one minute and thus may be predetermined time) worth of the video data from the beginning of the video reproduced, and displays the video on the monitor apparatus 12. The one minute's worth of the video data from the beginning of reproduction is once stored into a RAM (not shown) or the HD 14 inside the hard disc device 3, compressed at the minimum bit rate, and then reproduced.

Subsequently, a confirmation screen as shown in FIG. 3 is displayed on the monitor apparatus 12, and if the user views and approves the rough image quality of the video tentatively reproduced and displayed, the user operates the remote controller 11 to select and determine “YES” on the confirmation screen to provide an instruction for executing the duplication (step S6). The duplication starting part 103 of the system controller 10 operates the hard disc device 3 to perform reproduction and operates the optical disc device 2 to perform recording so as to start the duplication of the compressed video data targeted for duplication (for example, the program selected on the duplication setting screen of FIG. 2) from the HD 14 to the DVD 13 (step S7).

However, in step S5, if the user views the video tentatively reproduced and is not satisfied with the rough image quality thereof and then when the user selects and determines “NO” on the confirmation screen of FIG. 3, the processing proceeds to step S8. In step S8, the duplication setting screen of FIG. 2 is displayed again, and the bit rate is changed by setting the DVD recording bit rate at 1 step higher (bit rate LP). Then, an instruction for confirming the video is provided (step S4), and, as is the case above, one minute's worth of the video data from the beginning of the video is compressed and reproduced (step S5).

Then, if an instruction for executing the duplication is provided (step S6), the duplication starting part 103 of the system controller 10 operates the hard disc device 3 to perform reproduction and also operates the optical disc device 2 to perform recording so as to start duplicating the video data targeted for duplication and previously compressed (for example, the program selected on the duplication setting screen of FIG. 2) from the HD 14 to the DVD 13 (step S7). If no instruction for confirming the video is provided, the selected video data is compressed to start the duplication without performing tentative reproduction (step S7).

Through the processing as described above, the duplication is started, and when the duplication of the information from the HD 14 to the DVD 13 ends (step S10), this processing ends.

As described above, according to this embodiment, when the recording bit rate is changed upon the duplication of information from the HD 14 to the DVD 13, the video at this point can be confirmed. Therefore, upon the duplication of the information recorded on the HD 14 to the DVD 13, the user can be notified in advance that setting the bit rate of recording on the DVD 13 too low results in rough image quality of the video when reproduced from the DVD 13. Consequently, the video reproduced after the duplication is prevented from appearing hardly visible, thus avoiding user discomfort, failure in the duplication, and waste of the DVD 13.

What is claimed is:

1. A multiple-drive recording and reproduction apparatus comprising: an optical disc device that performs information recording and reproduction on an optical disc; and a hard disc device that performs information recording and reproduction on a hard disc, the multiple-drive recording and reproduction apparatus further comprising a system controller which, upon duplication of the information recorded on the hard disc to the optical disc, on a hard disc device side, compresses and tentatively reproduces, at a bit rate changed, predetermined time's worth of video data from beginning of a video and displays the video on a display part, and if a user views and approves rough image quality of the video tentatively reproduced and displayed, compresses the video data targeted for duplication and starts the duplication.

2. The multiple-drive recording and reproduction apparatus according to claim 1,
wherein the system controller comprises: a compression judgment part which judges, on a duplication setting screen displayed upon duplication mode setting for the duplication of the information recorded on the hard disc to the optical disc, whether or not an instruction for compressing the video data to be duplicated by changing the bit rate to a lower rate is provided; a tentative reproduction part which, if it is judged that the instruction for the compression is provided and then when an instruction for confirming the video to be reproduced at the bit rate is provided, on the hard disc device side, compresses and tentatively reproduces, at the bit rate, the predetermined time's worth of the video data from the beginning of the video and displays the video on the display part; and a duplication starting part which, if the user views and approves the rough image quality of the video tentatively reproduced and displayed and then when an instruction for executing the duplication is provided, starts the duplication of the compressed video data targeted for duplication.

3. An multiple-drive recording and reproduction apparatus comprising: an optical disc device that performs information recording and reproduction on an optical disc, and a hard disc device that performs information recording and reproduction on a hard disc, the multiple-drive recording and reproduction apparatus further comprising a system controller having: a compression judgment part which judges, on a duplication setting screen displayed upon duplication mode setting for duplication of the information recorded on the hard disc to the optical disc, whether or not an instruction for compressing video data to be duplicated by changing a bit rate to a lower rate is provided; a tentative reproduction part which, if it is judged that the instruction for the compression is provided and then when an instruction for confirming a video to be reproduced at the bit rate is provided, on the hard disc device side, compresses and tentatively reproduces, at the bit rate, predetermined time's worth of the video data from beginning of the video and displays the video on the display part; and a duplication starting part which, if a user views and approves rough image quality of the video tentatively reproduced and displayed and then when an instruction for executing the duplication is provided, starts the duplication of the compressed video data targeted for duplication.
